(19) United States
(12) Patent Application Publication
(10) Pub. No.: US 2012/0318120 A1
(43) Pub. Date: Dec. 20, 2012

(54) PRINTED MATERIAL WITH MUSICAL SCORE AND DISPLAY APPARATUS FOR DISPLAYING MUSICAL SCORE OF PRINTED MATERIAL WITH MUSICAL SCORE

(75) Inventor: Daigo ABE, Tokyo (JP)

(73) Assignee: Dwango Co., Ltd., Tokyo (JP)

(21) Appl. No.: 13/495,191

(22) Filed: Jun. 13, 2012

(30) Foreign Application Priority Data
Jun. 17, 2011 (JP) 2011-134748

(51) Int. Cl. G09B 15/02

(52) U.S. Cl. 84/477 R

(57) ABSTRACT

In conventional dance textbook, since there was no correlation between dance choreography and music, it was not easy to grasp the pace of dance upon dancing to the music. A ‘printed material with musical score’ 1 of the present invention, which is a musical score for expressing dance to the music, comprises a ‘first area for placement’, wherein an ‘area for dance motion’ 3, for expressing a ‘dance form’ 2 corresponding to each beat of the music is placed. According to this configuration, it is possible to learn a dance matching to the pace of music without the music by the correspondence between the beat of the music and the dance form.

### BACKGROUND OF THE INVENTION

1. Field of the Invention

The present invention relates to a musical score for practice of dancing to music.

2. Description of the Related Art

As the conventional dance textbook, a textbook for explaining dance choreographies in sequence with reference to pictures and descriptions exists. For example, in the Japanese Unexamined Patent Application Publication No. 2005-312493, a dance textbook teaching dancer's motions such as body positions, moving directions, and step lengths is disclosed. Moreover, In the Japanese Unexamined Patent Application Publication No. 2004-121775, a dance textbook for intuitive understanding of dancer's motions with minimum characters by utilizing colors and line symbols.

### RELATED ART DOCUMENTS

Patent Document 1: Japanese Unexamined Patent Application Publication No. 2005-312493
Patent Document 2: Japanese Unexamined Patent Application Publication No. 2004-121775

However, there is a deficiency in the conventional dance textbook that since there was no correlation between the dance choreography and the music, it was not easy to understand the pace of dance upon dancing to the music.

### SUMMARY OF THE INVENTION

It is an objective of the present invention to provide a printed material with musical score that is a musical score for expressing dance to the music, comprising a first area for placement, where an area for dance motion for expressing a dance form corresponding to each beat of the music is placed.

According to this configuration, it is possible to learn a dance matching the pace of music by the correspondence between the beat of the music and the dance form without the music.

### BRIEF DESCRIPTION OF THE DRAWINGS

FIG. 1 is a view exemplifying a printed material with musical score of a first embodiment.

FIG. 2 is a view exemplifying other printed material (1) with musical score of the first embodiment.

FIG. 3 is a view exemplifying other printed material (2) with musical score of the first embodiment.

FIG. 4 is a flowchart of a program for generating score information of the first embodiment.

FIG. 5 is a flowchart of a program for generating image of dance motion.

FIG. 6 is a view exemplifying a printed material with musical score of a second embodiment.

FIG. 7 is a flowchart of a program for generating score information of the second embodiment.

FIG. 8 is a flowchart of a program for generating information of sound.

FIG. 9 is a view exemplifying a printed material with musical score of a third embodiment.

FIG. 10 is a flowchart of a program for generating score information of the third embodiment.

FIG. 11 is a flowchart of a program for generating information of words.

FIG. 12 is a view exemplifying a printed material with musical score of a fourth embodiment.

FIG. 13 is a flowchart of a program for generating score information of the fourth embodiment.

FIG. 14 is a flowchart of a program for generating information of length of beat.

FIG. 15 is a view exemplifying a printed material with musical score of a fifth embodiment.

FIG. 16 is a flowchart of a program for generating score information of the fifth embodiment.

FIG. 17 is a flowchart of a program for generating enlarged image.

### DESCRIPTION OF THE PREFERRED EMBODIMENTS

Embodiments of the present invention will be described hereinafter. Relationships between embodiments and claims are as follows. The first embodiment will mainly describe Claims 1, 5, 6, 7 and 9. The second embodiment will mainly describe Claims 2 and 9. The third embodiment will mainly describe Claims 3 and 9. The fourth embodiment will mainly describe Claims 4 and 9. The present invention is not to be limited to the above embodiments and able to be embodied in various forms without departing from the scope thereof.

### First Embodiment

<Outline of First Embodiment>

A printed material with musical score of a first embodiment is a musical score for expressing dance to the music, and an area for dance motion for expressing a dance form corresponding to each beat of the music is placed therein. According to this configuration, it is possible to learn a dance matching the pace of music by the correspondence between the beat of the music and the dance form without the music.

<Configuration of First Embodiment>

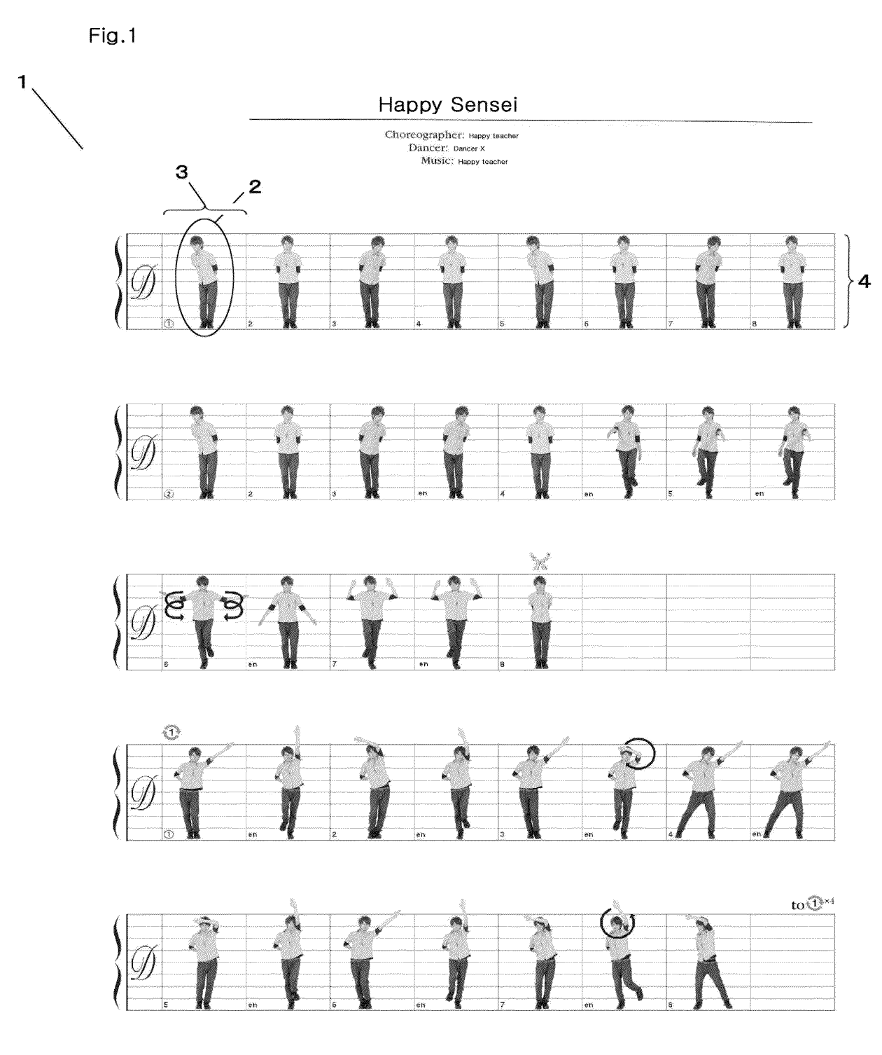

FIG. 1 is a view exemplifying a printed material with musical score of the first embodiment. As shown in FIG. 1, a ‘printed material with musical score’ 1 of the first embodiment is a musical score for expressing dance to the music, and comprises a ‘first area for placement’ 4, where an ‘area for dance motion’ 3 for expressing a ‘dance form’ 2 corresponding to each beat of the music is placed.

The beat is a time unit of basic rhythm, which is counted at equal intervals. The basic rhythm is called as a meter. An ideal dance form varies according to the rhythm, and a skilled dancer can dance to the rhythm. However, it is difficult for a beginner and a poor dancer to dance to the rhythm, and learning only an order and forms of dance cannot improve their dancing in many cases.

According to the printed material with musical score of the first embodiment, since a dance form corresponding to each beat is displayed, it is possible for a person viewing this to check the rhythm of the music and to learn the order and forms of dance. Note that examples of the music utilizing the printed material with musical score of the first embodiment include pop music, classic music, rock music, Japanese ballads, and classical music, and it is not limited to a specific genre of music.

The dance form may be displayed by an image of dancing that has been shot, and may be displayed by a graphic or a picture for expressing the dance. The dance form is displayed by the image, thereby helping the person viewing this imagine the dance form.

Moreover, various dance forms may be utilized according to the type of music. Examples of the dance form include a dance using whole body, a dance using a part of body, a dance composed of a dancer, and a dance composed of a plurality of dancers. In the area of dance motion, motion of the whole body and motion of a part of the body are displayed, such that the dance form is clarified. Note that in the case of the dance composed of a plurality of dancers, all or a part of the motions of the plurality of dancers are displayed in the area for dance motion.

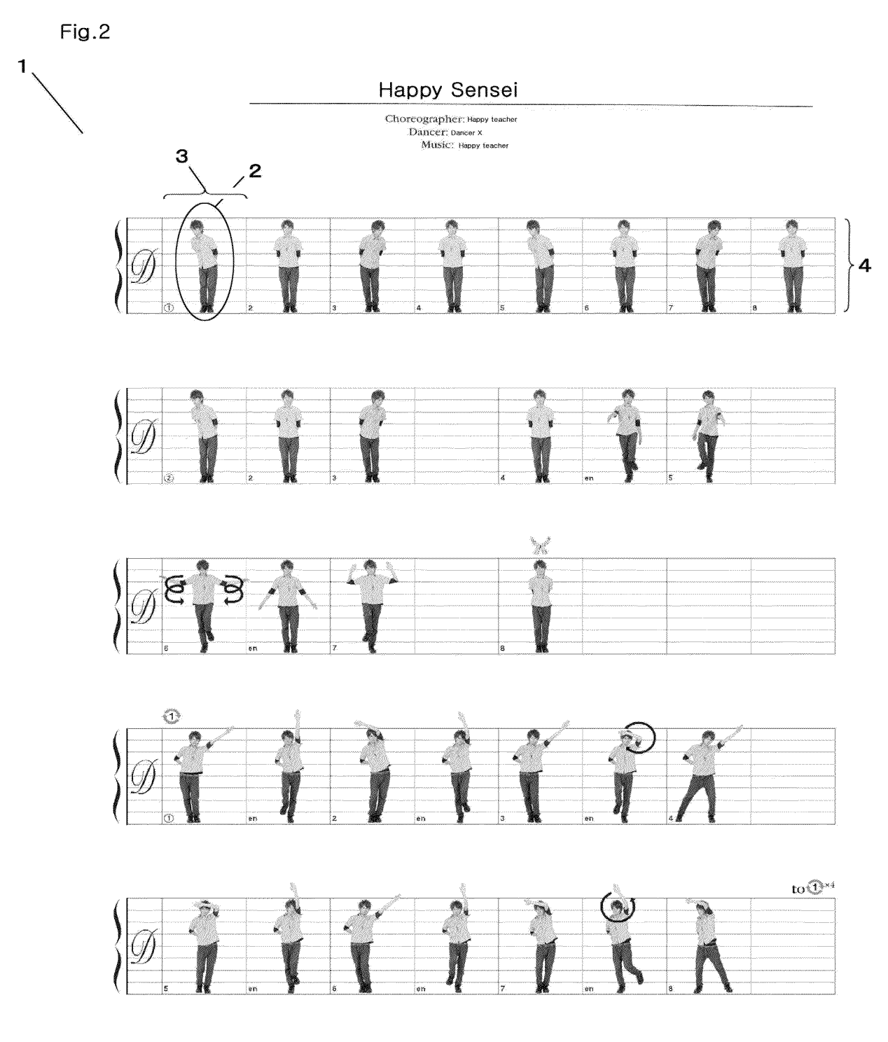

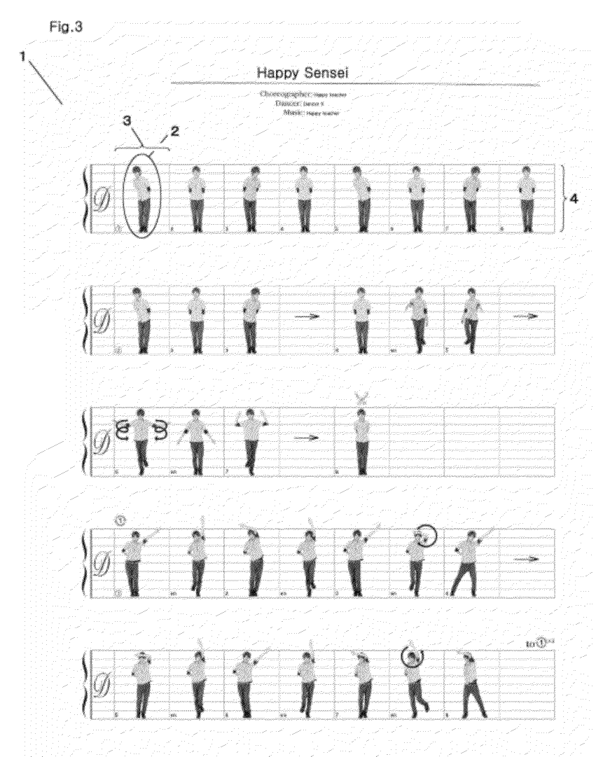

Moreover, as shown in FIG. 2, it is preferable that, when consecutive areas for dance motion have the same dance form, a dance form displayed in an initial area is not displayed in a subsequent area for dance motion. Here, when not displaying the dance form in the subsequent area for dance motion, as shown in FIG. 3, it is possible to display an arrow indicating continuation of the same dance form, or to display a symbol indicating that dance forms are the same, although it is possible to display the same dance form in the respective areas for dance motion when continuing the same dance form, it is necessary for the person viewing this to check whether the dance forms displayed in the respective areas for dance motion are the same. Therefore, when continuing the same dance form, a dance form displayed in an initial area is not displayed in subsequent areas for dance motion, thereby clarifying that the dance forms are the same. Accordingly, the person viewing this can immediately understand that the same dance form is continued.

As shown in FIGS. 1 to 3, a quadrangular area can be used for the area for dance motion, and other area shapes such as a circular area and polygonal area may be used. Moreover, an outline of the area for dance motion is not necessary to be defined by a frame, and any area having a predetermined size for displaying the dance form can be used.

The placement of the area for dance motion is to place areas for dance motion in order. Note that, when placing, as shown in FIGS. 1 to 3, the areas for dance motion are placed rightward, and may be placed leftward, or vertically. Moreover, there is no limitation on the placement, and any number of columns of area for dance motion per line may be placed, and any number of lines of area for dance motion may be placed in a column. As shown in FIG. 1, eight areas for dance motion may be placed per line, and other number of areas for dance motion per line may be placed.

Note that, it is preferable that eight areas for dance motion are placed as a set in the first area for placement. In many cases, eight strong beats (on-count) are basically counted as one section in dance, and when learning the dance, eight dance forms are regarded as a set in many cases. For example, corresponding eight dance forms are learned while calling out ‘one, two, three, four, five, six, seven, eight’. In this case, the eight areas for dance motion are placed as a set, thereby easily learning one set of the eight dance forms. Moreover, as a method for composing the one set of eight areas for dance motion, in addition to the placement of the eight areas for dance motion per line, numbers 1 to 8 may be indicated in a part of the respective areas for dance motion, or lines or symbols as a separation may be indicated with respect to each set of eight areas for dance motion.

Moreover, when dance motion of a part of a body is characteristic, a graphic or symbol for indicating the motion may be displayed near the part of the body. In FIG. 1, in the area for dance motion displaying a dance form with a rotation of arm, an arrow indicating a direction of the rotation is indicated near the arm, and in the area for dance motion displaying a dance form with spiral and downward motion of both arms, spiral symbols are indicated near both arms.

<Display Apparatus>

The display information of the printed material with musical score of the first embodiment is not always provided by paper media, and may be displayed by a display. In this case, the display apparatus acquires the display data of the printed material with musical score through communication line, or from an external storage device, thereby outputting the display data to the display. Moreover, the display apparatus may internally generate the display data of the printed material with musical score and may display the display data.

Note that, when displaying the display data of the printed material with musical score on the display, it is not always necessary to display the entire printed material with musical score within one screen, and it is preferable to display a part of the printed material with musical score, such that a series of dance forms can be understood. For example, when displaying the eight dance forms per line, display is carried out, such that at least dance forms in a line are displayed within one screen.

Moreover, in the display apparatus, it is possible to count up beats simultaneously with reception of an input operation of a start button, thereby switching the display area according to the count value, or carrying out scroll display. Moreover, it is possible to highlight the corresponding area for dance motion according to the count value, such that the area is distinguishable from other areas for dance motion.

Moreover, in the display apparatus, it is possible to output sound to notify user of the pace of the music according to the count value in accordance with the display data of the printed material with musical score. In this case, mechanical sound, like that of a metronome, or a human voice calling out (e.g., ‘one, two, three, four, five, six, seven, eight’) may be outputted.

Moreover, in the display apparatus, it is possible to display the display data of the printed material with musical score on the display according to specific instructions from a user. For example, when a user upon playing a dance game sends instructions to display (e.g., instructions to display a help menu) the musical score in order to check the dance form, the display apparatus outputs the musical score information to the display. Accordingly, the user can easily understand the dance form of the dance game.

<Program for Generating Musical Score Information>

The information of the printed material with musical score that is a musical score of the first embodiment can be generated by execution of a program for generating musical score information by a CPU. The program may be executed by the above-mentioned display apparatus, or by the other apparatus for providing the information to the display apparatus through the communication line etc. Hereinafter, a description of processing flow when the CPU executes the program will be provided. Note that, the program for generating musical score information may be activated by a user, or may be activated by reading out from other program.

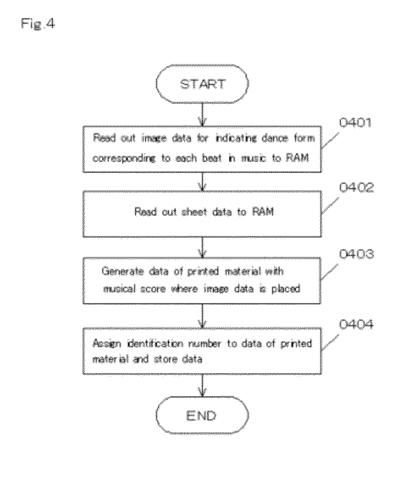

FIG. 4 is a flowchart when the program for generating musical score information is executed by the CPU. At the outset, in a step S0401, the CPU executes a step of acquiring image of dance motion, and reads out the image data for displaying the dance form corresponding to each beat in the music, stored in a long-term storage area, to a RAM. A description of the generation of the image data will be provided in the after-mentioned ‘program for generating image of dance motion’. Subsequently, in a step S0402, the CPU executes a step of acquiring sheet data, and reads out the sheet data for placing the image data for displaying the dance form from the long-term storage to the RAM. The sheet data includes information of image size to be placed, information of coordinate for placing the respective images, and information of position of a frame for separating the respective areas for dance motion. Subsequently, in a step S0403, the CPU executes a step of generating data of printed material with musical score, thereby generating the data of placement of the image data for displaying the dance form corresponding to each beat of the music (data of printed material with musical score) on the basis of the sheet data. When the image data for displaying the dance form does not fulfill required image size and number of pixels, a processing of conversion for fulfilling the requirement is carried out. Subsequently, in a step S0404, the CPU executes a step of storing musical score data, thereby assigning identification information to the generated data of printed material with musical score, and storing the data in the long-term storage area.

<Program for Generating Image of Dance Motion>

The image data for displaying the dance form corresponding to each beat of the music utilized upon execution of the program for generating musical score information can be generated by manual imaging, and may be automatically generated by executing the program for generating image of dance motion. Hereinafter, a description of processing flow when the CPU executes the program will be provided. Note that, the program for generating image of dance motion may be activated by a user, or may be activated by reading out from other program (e.g., program for generating musical score information).

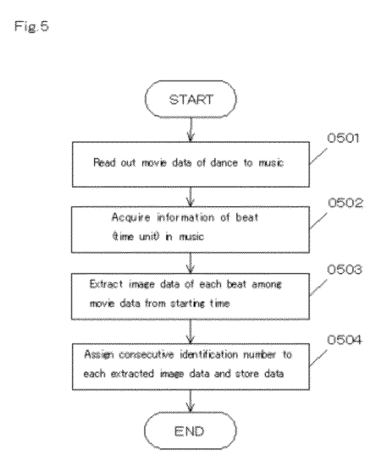

FIG. 5 is a flowchart when the program for generating image of dance motion is executed by the CPU. At the outset, in a step S0501, the CPU executes a step of acquiring movie, and reads out the movie data of the dance to the music, stored in a long-term storage area, to the RAM. Here, the movie data may be preliminarily acquired through the communication line, or may be preliminarily shot. In a step S0502, the CPU executes a step of acquiring information of beat, thereby analyzing music data in the read out movie data, and acquiring the information of beat (time unit) in the music. For example, by detecting voice level and repetition of melody, it is possible to extract length of beat in the respective parts in the music. Subsequently, in a step S0503, the CPU executes a step of extracting dance motion, thereby extracting the image data corresponding to each beat from starting time among the read out movie data. Subsequently, in a step S0504, the CPU executes a step of storing dance image data, thereby assigning consecutive identification number to the respective extracted image data, and storing the data in the long-term storage area.

<Effects of First Embodiment>

According to the printed material with musical score of the first embodiment, it is possible to learn a dance matching to the pace of the music by the correspondence between the beat of the music and the dance form without the music.

### Second Embodiment

<Outline of Second Embodiment>

A printed material with musical score of a second embodiment is basically the same as that of the first embodiment, and further placing an area for musical note for displaying musical note corresponding to each beat of the music therein. According to this configuration, it is possible to learn a dance matching to the pace of the music without the music by the correspondence between the beat of the music and the dance form.

<Configuration of Second Embodiment>

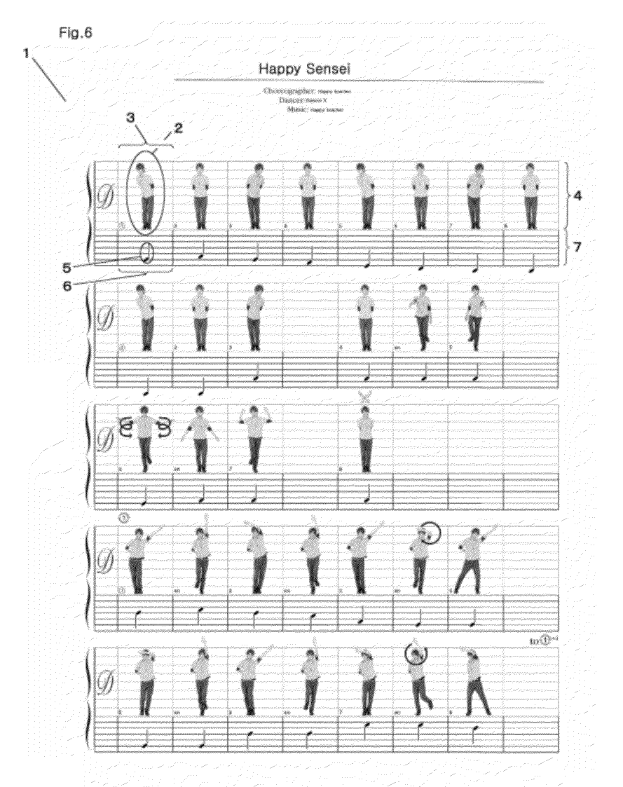

FIG. 6 is a view exemplifying a printed material with musical score of the second embodiment. As shown in FIG. 6, a ‘printed material with musical score’ 1 of the second embodiment is a musical score for expressing dance to the music, and comprises a ‘first area for placement’ 4, where an ‘area for dance motion’ 3 for expressing a ‘dance form’ 2 corresponding to each beat of the music is placed, and a ‘second area for placement’ 7, where an ‘area for musical note’ 6 for expressing a ‘musical note’ 5 corresponding to each beat of the music is placed. Hereinafter, a description of the second area for placement, which is a feature of the second embodiment, will be provided.

In the printed material with musical score of the second embodiment, the musical note is displayed in the area for musical note corresponding to each beat of the music. Therefore, it is possible to understand length and pitch of each sound by checking the musical note, and even when rhythm of the music greatly varies in the music, it is possible to learn dance form corresponding to each beat on the basis of the understanding of variation of rhythm. Note that examples of the musical note include dotted notes, double-dotted notes, and a set of notes. Moreover, the musical notes include notes indicating only length of sound (rhythm notes). In this case, only rhythm is indicated, and is effective enough to learn the dance to the beat of the music.

Moreover, other than the musical notes, rest may be added. It is possible to understand length of rest of sound by checking the rest, and on the basis thereof, it is possible to learn the dance form corresponding to each beat. Examples of the rest include dotted rests and double-dotted rests.

As shown in FIG. 6, a quadrangular area can be used for the area for dance motion, and other shapes of area such as a circular area and polygonal area may be used, and it is not limited to this example. Moreover, an outline of the area for musical note is not necessary to be defined by a frame, and any area, having a predetermined size for displaying the musical note corresponding to each beat of the music, can be used. Moreover, although it is assumed that staff is drawn on the area for musical note in order to clarify the pitch of the musical note, this is unnecessary when the musical note indicates only the rhythm, and is not essential.

Moreover, the area for musical note may share all or a part of the area with the area for dance motion. In this case, it is assumed that the dance form corresponding to each beat of the music overlaps with the musical note corresponding to each beat of the music. This can be solved by using different colors etc, to provide distinguishability.

The placement of the area for musical note is to place areas for musical note in order. Note that, since both of the area for musical note and the area for dance motion are on the basis of the beat as a unit, and the areas are placed in the same placement manner. Therefore, number of lines or columns of the second area for placement is the same as that of the first area for placement. For example, when placing the areas for dance motion rightward, the areas for musical note are also placed rightward in parallel with or overlapping with the area for dance motion.

<Program for Generating Musical Score Information>

The information of the printed material with musical score that is a musical score of the second embodiment can be generated by execution of a program for generating musical score information by a CPU. Hereinafter, a description of processing flow when the CPU executes the program will be provided.

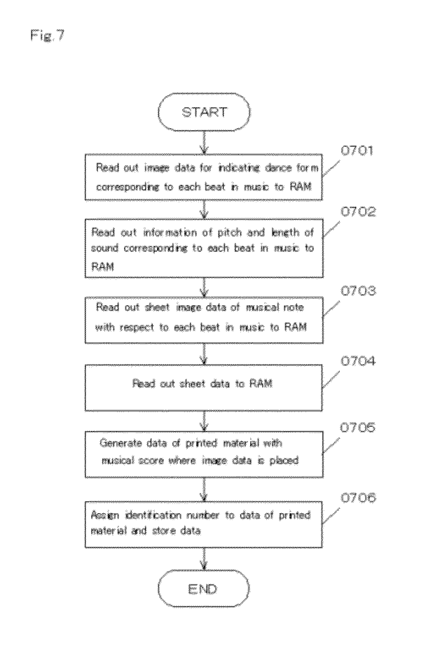

FIG. 7 is a flowchart when the program for generating musical score information is executed by the CPU. At the outset, in a step S0701, the CPU executes a step of acquiring image of dance motion, and reads out the image data for displaying the dance form corresponding to each beat in the music, stored in a long-term storage area, to the RAM. Subsequently, in a step S0702, the CPU executes a step of acquiring information of sound, and reads out the information of sound, which is information of pitch and length of the sound corresponding to each beat of the music, and stored in the long-term storage, to the RAM. A description of the generation of the information will be provided in the after-mentioned ‘program for generating information of sound’. Subsequently, in a step S0703, the CPU reads out the image data of the musical note corresponding to the pitch and length of the sound for each beat of the music from the long-term storage area to the RAM. Subsequently, in a step S0704, the CPU executes a step of acquiring sheet data, thereby reading out the sheet data for placing the image data for displaying the dance form and the musical note from the long-term storage to the RAM. The sheet data includes table information of coordinate for placing the musical note varying according to the pitch of sound, and table information for indicating position of a frame for separating the respective areas for musical note. Subsequently, in a step S0705, the CPU executes a step of generating data of printed material with musical score, thereby generating the data of placement of the image data for displaying the dance form and the image data of the musical note corresponding to each beat of the music (data of printed material with musical score) on the basis of the information of the sheet data. Subsequently, in a step S0706, the CPU executes a step of storing musical score data, thereby assigning identification information to the generated data of printed material with musical score, and storing the data in the long-term storage area.

<Program for Generating Information of Sound>

The information of sound corresponding to each beat of the music utilized upon execution of the program for generating musical score information can be generated by manual imaging, and may be automatically generated by executing the program for generating information of sound. Hereinafter, a description of processing flow when the CPU executes the program will be provided. Note that, the program for generating information of sound may be activated by a user, or may be activated by reading out from another program (e.g., program for generating musical score information).

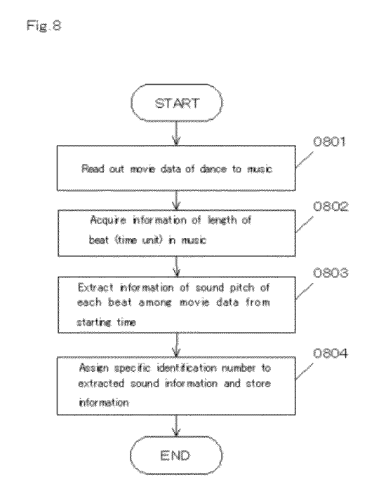

FIG. 8 is a flowchart when the program for generating information of sound is executed by the CPU. At the outset, in a step S0801, the CPU executes a step of acquiring movie, and reads out the movie data of the dance to the music, stored in a long-term storage area, to the RAM. In a step S0802, the CPU executes a step of acquiring information of beat, thereby analyzing music data in the read out movie data, and acquiring the information of length (time unit) of beat (sound) in the music. Subsequently, in a step S0803, the CPU executes a step of extracting information of sound, thereby extracting pitch of the sound corresponding to each beat from starting time among the music data. Subsequently, in a step S0804, the CPU executes a step of storing information of sound, thereby assigning a specific identification number to the extracted information of sound for indicating the pitch and length of sound corresponding to each beat, and storing the information in the long-term storage area.

<Effects of Second Embodiment>

According to the printed material with musical score of the second embodiment, it is possible to learn a dance matching to the pace of the music without the music by the correspondence between the beat and the melody of the music and the dance form.

### Third Embodiment

<Outline of Third Embodiment>

A printed material with musical score of a third embodiment is basically the same as that of the first embodiment, and further placing an area for words for displaying words corresponding to each beat of the music therein. According to this configuration, it is possible to learn a dance matching to the pace of the music without the music by the correspondence between the beat of the music and the dance form.

<Configuration of Third Embodiment>

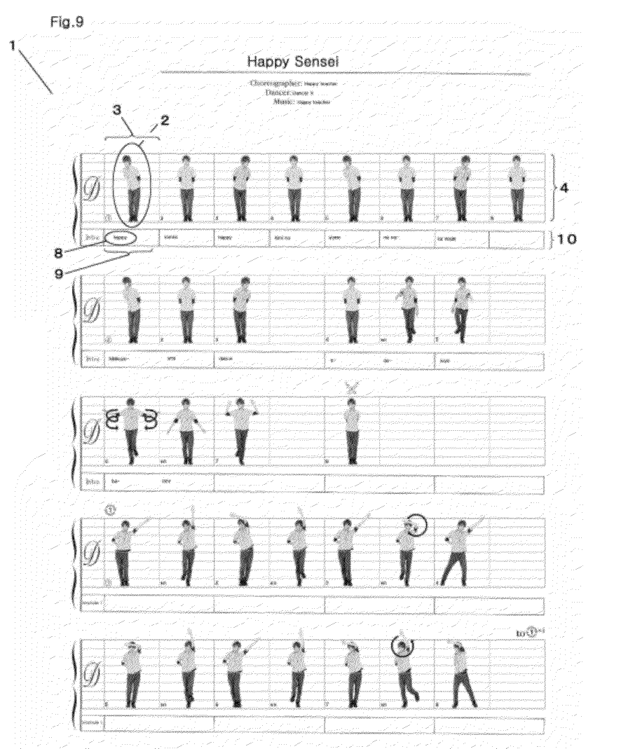

FIG. 9 is a view exemplifying a printed material with musical score of the third embodiment. As shown in FIG. 9, a ‘printed material with musical score’ 1 of the third embodiment is a musical score for expressing dance to the music, and comprises a ‘first area for placement’ 4, where an ‘area for dance motion’ 3 for expressing a ‘dance form’ 2 corresponding to each beat of the music is placed, and a ‘third area for placement’ 10, where an ‘area for words’ 9 for expressing corresponding ‘words’ 8 corresponding to each beat of the music is placed. Hereinafter, a description of a feature of the third area for placement, which is a difference from the first and second embodiments, will be provided.

In the printed material with musical score of the third embodiment, the words corresponding to each beat of the music are displayed in the area for words. Therefore, it is possible to understand the correspondence between the words and the dance form by checking the words and the dance form, thereby learning the dance form corresponding to each beat imaging the words.

As shown in FIG. 9, a quadrangular area can be used for the area for dance motion, and other shape of area such as a circular area and polygonal area may be used, and it is not limited to this example. Moreover, an outline of the area for words is not necessary to be defined by a frame, and any areas, having a predetermined size for displaying the words corresponding to each beat of the music, can be used.

Moreover, the area for words may share all or a part of the area with the area for dance motion. In this case, it is assumed that the dance form corresponding to each beat of the music overlaps with the words corresponding to each beat of the music. This can be solved by using different colors etc, to provide distinguishability.

The placement of the area for musical note is to place areas for words in order. Note that, since both of the area for words and the area for dance motion are on the basis of the beat as a unit, and the areas are placed in the same placement manner. Therefore, number of lines or columns of the third area for placement is the same as that of the first area for placement. For example, when placing the areas for dance motion rightward, the areas for words are also placed rightward in parallel with or overlapping with the area for dance motion.

<Program for Generating Musical Score Information>

The information of the printed material with musical score that is a musical score of the third embodiment can be generated by execution of a program for generating musical score information by a CPU. Hereinafter, a description of processing flow when the CPU executes the program will be provided.

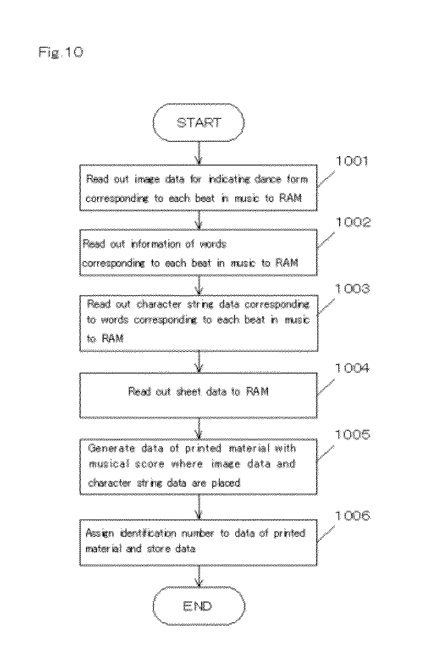

FIG. 10 is a flowchart when the program for generating musical score information is executed by the CPU. At the outset, in a step S1001, the CPU executes a step of acquiring image of dance motion, and reads out the image data for displaying the dance form corresponding to each beat in the music, stored in a long-term storage area, to the RAM. Subsequently, in a step S1002, the CPU executes a step of acquiring information of words, and reads out the information of words, which is information of the words corresponding to each beat of the music, and stored in the long-term storage, to the RAM. A description of the generation of the information will be provided in the after-mentioned ‘program for generating information of words’. Subsequently, in a step S1003, the CPU reads out the image data of the character string corresponding to the words for each beat of the music from the long-term storage area to the RAM. Subsequently, in a step S1004, the CPU executes a step of acquiring sheet data, thereby reading out the sheet data for placing the image data for displaying the dance form and the words from the long-term storage to the RAM. The sheet data includes information of coordinate for placing the character string for indicating the respective words, and information for indicating position of a frame for separating the respective areas for words.

Subsequently, in a step S1005, the CPU executes a step of generating data of printed material with musical score, thereby generating the data of placement of the image data for displaying the dance form and the image data of the character string for indicating the respective words corresponding to each beat of the music (data of printed material with musical score) on the basis of the information of the sheet data. Subsequently, in a step S1006, the CPU executes a step of storing musical score data, thereby assigning identification information to the generated data of printed material with musical score, and storing the data in the long-term storage area.

<Program for Generating Information of Sound>

The information of words corresponding to each beat of the music utilized upon execution of the program for generating musical score information can be generated by manual imaging, and may be automatically generated by executing the program for generating information of words. Hereinafter, a description of processing flow when the CPU executes the program will be provided. Note that, the program for generating information of words may be activated by a user, or may be activated by reading out from other program (e.g., program for generating musical score information).

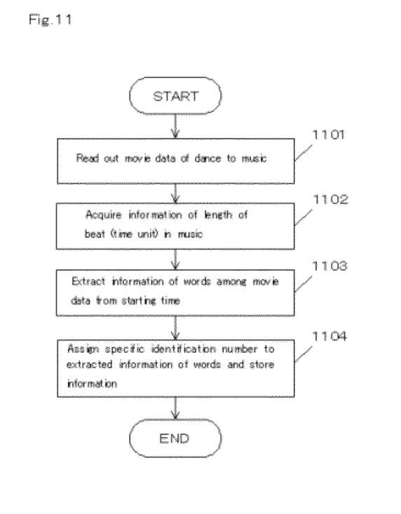

FIG. 11 is a flowchart when the program for generating information of words is executed by the CPU. At the outset, in a step S1101, the CPU executes a step of acquiring movie, and reads out the movie data of the dance to the music, stored in a long-term storage area, to the RAM. In a step S1102, the CPU executes a step of acquiring information of beat, thereby analyzing music data in the read out movie data, and acquiring the information of length (time unit) of beat (sound) in the music. Subsequently, in a step S1103, the CPU executes a step of extracting information of words, thereby extracting the information of words corresponding to each beat from starting time among the music data. Here, when the information of words is not included in the music data, the information of words may be acquired by analyzing the sound output data, or may be acquired by automatically downloading the information of words through the network. Subsequently, in a step S1104, the CPU executes a step of storing information of words, thereby assigning a specific identification number to the extracted information of words for indicating the words corresponding to each beat, and storing the information in the long-term storage area.

<Effects of Third Embodiment>

According to the printed material with musical score of the third embodiment, it is possible to learn a dance matching to the pace of the music without the music by the correspondence between the beat and the words of the music and the dance form.

### Fourth Embodiment

<Outline of Fourth Embodiment>

A printed material with musical score of a fourth embodiment is basically the same as that of the first embodiment, and further placing the area for dance motion for displaying dance form corresponding to each beat of the music, such that a size of the area for dance motion varies according to length of the beat of the music when the length of the beat varies within the music. According to this configuration, it is possible to learn the dance form corresponding to each beat understanding the length of the beat of the music.

<Configuration of Fourth Embodiment>

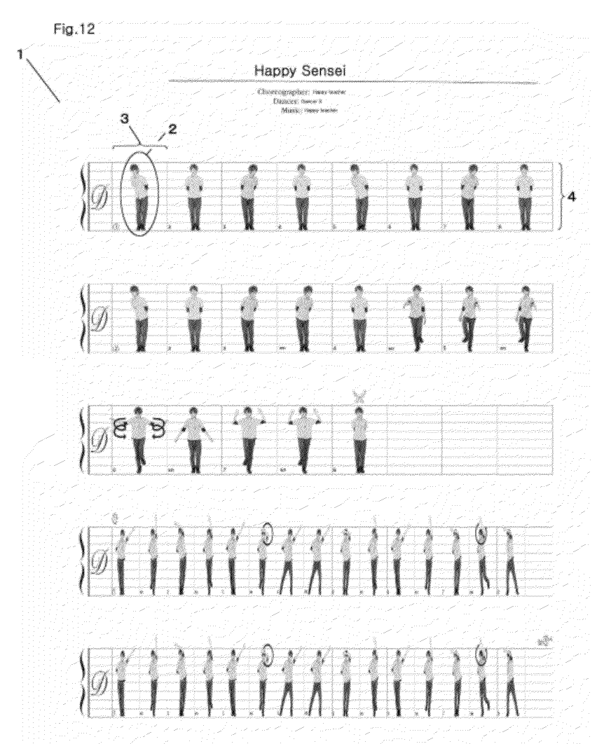

FIG. 12 is a view exemplifying a printed material with musical score of the fourth embodiment. As shown in FIG. 12, a ‘printed material with musical score’ 1 of the fourth embodiment is a musical score for expressing dance to the music, and comprises a ‘first area for placement’ 4, where an ‘area for dance motion’ 3 for expressing a ‘dance form’ 2 corresponding to each beat of the music is placed, and the area for dance motion for displaying dance form corresponding to each beat of the music, such that a size of the area for dance motion varies according to length of the beat of the music when the length of the beat varies within the music Moreover, as described in the second and third embodiments, the second area for placement, for displaying the musical note corresponding to each beat of the music, and the third area for placement, where the area for words for expressing words corresponding to each beat of the music is placed, may be provided simultaneously. Hereinafter, a description of a feature of the first area for placement, which is a difference from the first to third embodiments, will be provided.

In the printed material with musical score of the fourth embodiment, the size of the area for dance motion varies according to length of the beat of the music when the length of the beat varies within the music. In many cases, when a pace thereof varies in music, a pace of the dance motion varies according the variation of the pace. Even in such case, it is possible to simultaneously understand the length of the beat and the dance motion corresponding thereto by checking the length of the area for dance motion, thereby learning the dance form corresponding to each beat checking the length of the beat.

Specifically, in one part of the music (e.g., an introduction), the length of the area for dance motion may be one-eighth of a line, and in other parts (e.g., interludes), where the length of the beat is a half of that of the one part, the length of the area for dance motion may be one-sixteenth of the line. Moreover, at the point, where the length of beat of the music varies, it is possible to indicate a special symbol or character in order to clarify the point.

<Program for Generating Musical Score Information>

The information of the printed material with musical score that is a musical score of the fourth embodiment can be generated by execution of a program for generating musical score information by a CPU. The execution of the program may be carried out by the above-mentioned display apparatus, or by the other apparatus providing the information to the display apparatus through the communication line. Hereinafter, a description of processing flow when the CPU executes the program will be provided. Note that, the program for generating information of musical score may be activated by a user, or may be activated by other program.

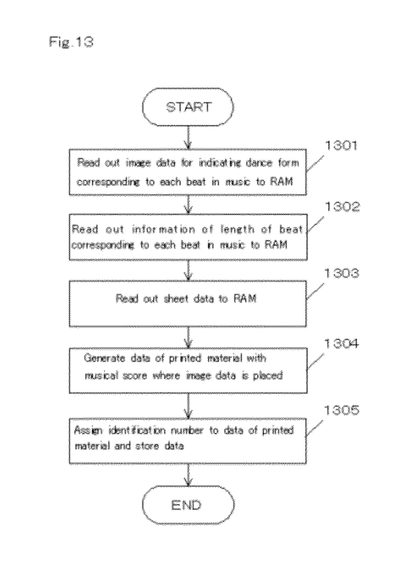

FIG. 13 is a flowchart when the program for generating musical score information is executed by the CPU. At the outset, in a step S1301, the CPU executes a step of acquiring image of dance motion, and reads out the image data for displaying the dance form corresponding to each beat in the music, stored in a long-term storage area, to the RAM. Subsequently, in a step S1302, the CPU executes a step of acquiring information of beat, and reads out the information of beat, which is information of length of beat for each beat of the music, and stored in the long-term storage, to the RAM. A description of the generation of the information will be provided in the after-mentioned ‘program for generating information of length of beat’. Subsequently, in a step S1303, the CPU executes a step of acquiring sheet data, thereby reading out the sheet data for placing the image data for displaying the dance form from the long-term storage to the RAM. The sheet data includes table information of coordinate for placing the respective images, and the table information of image size, which vary according to the length of beat, and information for indicating position of a frame for separating the respective areas for words.

Subsequently, in a step S1304, the CPU executes a step of generating data of printed material with musical score, thereby generating the data of placement of the image data for displaying the dance form corresponding to each beat of the music (data of printed material with musical score) on the basis of the information of the sheet data. Subsequently, in a step S1305, the CPU executes a step of storing musical score data, thereby assigning identification information to the generated data of printed material with musical score, and storing the data in the long-term storage area.

<Program for Generating Information of Sound>

The information of words corresponding to each beat of the music utilized upon execution of the program for generating musical score information can be generated by manual imaging, and may be automatically generated by executing the program for generating information of words. Hereinafter, a description of processing flow when the CPU executes the program will be provided. Note that, the program for generating information of words may be activated by a user, or may be activated by reading out from other program (e.g., program for generating musical score information).

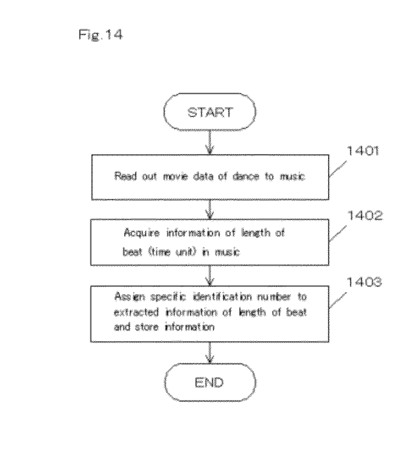

FIG. 14 is a flowchart when the program for generating information of length of beat is executed by the CPU. At the outset, in a step S1401, the CPU executes a step of acquiring movie, and reads out the movie data of the dance to the music, stored in a long-term storage area, to the RAM. In a step S1402, the CPU executes a step of acquiring information of length of beat, thereby analyzing music data in the read out movie data, and acquiring the information of length (time unit) of beat (sound) in the music. Subsequently, in a step S1403, the CPU executes a step of storing information of length of beat, thereby assigning a specific identification number to the extracted information of length of beat for indicating the length of beat for each beat, and storing the information in the long-term storage area.

<Effects of Fourth Embodiment>

According to the printed material with musical score of the fourth embodiment, it is possible to learn the dance form corresponding to each beat while understanding the length of the beat of the music.

### Fifth Embodiment

<Outline of Fifth Embodiment>

A printed material with musical score of a fifth embodiment is basically the same as that of the first to fourth embodiments, and when the dance form is characterized by a part of a body, an image of the part of the body is enlarged in response to the beat of the music. According to this configuration, it is possible to learn dance form corresponding to each beat while particularly understanding the characteristic part of the body.

<Configuration of Fifth Embodiment>

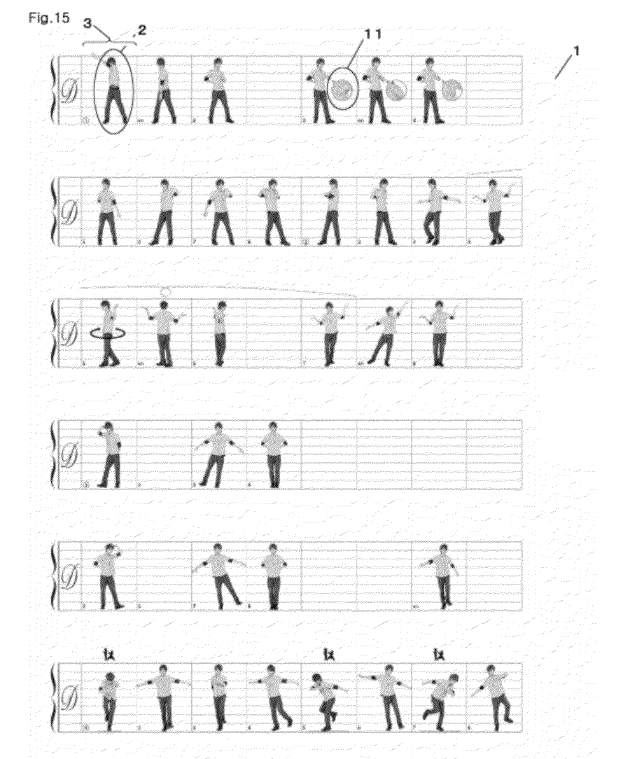

FIG. 15 is a view exemplifying a printed material with musical score of the fifth embodiment. As shown in FIG. 15, a ‘printed material with musical score’ 1 of the fifth embodiment is a musical score for expressing dance to the music, and comprises a ‘first area for placement’ 4, where an ‘area for dance motion’ 3 for expressing a ‘dance form’ 2 corresponding to each beat of the music is placed, and when the dance form is characterized by a part of a body, an ‘enlarged image’ 11 of the part of the body is displayed in the area for dance motion. Moreover, as described in the second, third, and fourth embodiments, the second area for placement, for displaying the musical note corresponding to each beat of the music, and the third area for placement, where the area for words for expressing words corresponding to each beat of the music is placed, may be provided simultaneously. Hereinafter, a description of a feature of the first area for placement, which is a difference from the first to fourth embodiments, will be provided.

As described above, in the printed material with musical score of the fifth embodiment, when the dance form is characterized by a part of a body, an image of the part of the body is enlarged in the area for dance motion. For example, in music, the dance form is possibly characterized by motions of hands or motions of legs, or by facial expressions of a dancer. In such case, by enlarging the image of the characteristic part in the respective areas for dance motion, it is possible to particularly understand the dance form of the part of the body.

As the method for enlarging image of the part of the body, display in a part of the area for dance motion is possible, or display using the entire area for the dance motion is also possible. Moreover, when the dance form is characterized by a plurality of parts of the body, images of the plurality of parts may be respectively enlarged. Moreover, when enlarging an image of a part of a body while displaying an entire body in the area for dance motion, it is preferable to partially enlarge the corresponding part of the entire body. For example, when the dance form is characterized by motions of fingers of a hand, the corresponding part is enlarged near the fingers in the display of the entire body.

Moreover, when the dance form is characterized by a motion of the entire body, it is possible to display a graphic or symbol for indicating the motion of the entire body in the first area for placement or in a space outside of the first area for placement. For example, in FIG. 15, the dance form starting a turn is displayed in the first area for dance motion in the third line, and an arrow indicating a direction of the turn is displayed in response to the dance form. Moreover, in the upper part of the first to fifth areas for dance motion in the third line, an arrow indicating one turn (one-turn motion) is displayed. Moreover, in the upper parts of the first, fifth, and seventh areas for dance motion in the sixth line, graphics indicating low postures are displayed. Moreover, as other examples, it is possible to display a graphic indicating handclap or stamping, a symbol indicating a repetition of a sequence of dance motions, and a symbol indicating a jump to other part of the musical score in the area for dance motion or in the outside of the area for dance motion. By looking at such graphics or symbols, it is possible to easily understand the details of the dance forms displayed in the area for dance motion.

<Program for Generating Musical Score Information>

The information of the printed material with musical score that is a musical score of the fifth embodiment can be generated by execution of a program for generating musical score information by a CPU. Hereinafter, a description of processing flow when the CPU executes the program will be provided.

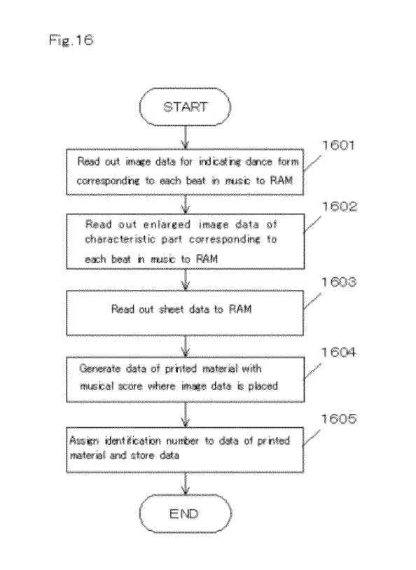

FIG. 16 is a flowchart when the program for generating musical score information is executed by the CPU. At the outset, in a step S1601, the CPU executes a step of acquiring image of dance motion, and reads out the image data for displaying the dance form corresponding to each beat in the music, stored in a long-term storage area, to the RAM. Subsequently, in a step S1602, the CPU executes a step of acquiring enlarged image, and reads out an image data of enlarging a characteristic part in the dance form corresponding to each beat of the music, stored in a long-term storage area, to the RAM. A description of the generation of the information will be provided in the after-mentioned ‘program for generating enlarged image data’. Subsequently, in a step S1603, the CPU executes a step of acquiring sheet data, thereby reading out the sheet data for placing the image for displaying the dance form and the enlarged image of the characteristic part in the dance form from the long-term storage to the RAM. The sheet data includes information of coordinate for placing the enlarged image etc. Note that, the enlarged image may not always be placed in all of the areas for dance motion. Subsequently, in a step S1604, the CPU executes a step of generating data of printed material with musical score, thereby generating the data of placement of the image data for displaying the dance form corresponding to each beat of the music and the enlarged image of the characteristic part in the dance form (data of printed material with musical score) on the basis of the information of the sheet data. Subsequently, in a step S1605, the CPU executes a step of storing musical score data, thereby assigning identification information to the generated data of printed material with musical score, and storing the data in the long-term storage area.

<Program for Generating Enlarged Image>

The enlarged image data corresponding to each beat of the music utilized upon execution of the program for generating musical score information can be generated by manual imaging, and may be automatically generated by executing the program for generating enlarged image. Hereinafter, a description of processing flow when the CPU executes the program will be provided. Note that, the program for generating enlarged image may be activated by a user, or may be activated by reading out from other program (e.g., program for generating musical score information).

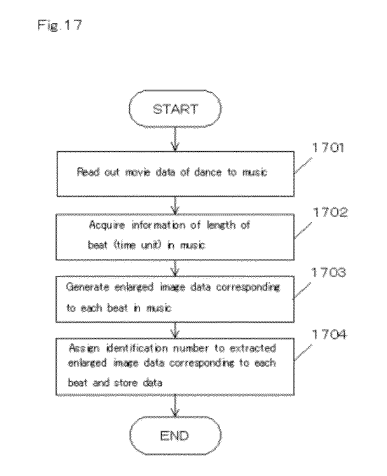

FIG. 17 is a flowchart when the program for generating enlarged image is executed by the CPU. At the outset, in a step S1701, the CPU executes a step of acquiring movie, and reads out the movie data of the dance to the music, stored in a long-term storage area, to the RAM. In a step S1702, the CPU executes a step of acquiring information of beat, thereby analyzing music data in the read out movie data, and acquiring the information of length (time unit) of beat (sound) in the music.

Subsequently, in a step S1703, the CPU executes a step of extracting characteristic part, thereby clipping a specific part of a body (e.g., a part of a hand) from the image data corresponding to each beat from starting time, and enlarging the part at a predetermined magnification. Here, the it is possible to carry out the clipping of the specific part of the body by comparing model data of the specific part of the body with the respective parts of the image data. Moreover, when the specific part of the body is not displayed in the image data, or when the specific part shows small variation in comparison with the image data of the last beat, the enlarged image may not be generated. Subsequently, in a step S1704, the CPU executes a step of storing enlarged image, thereby assigning consecutive identification number to the extracted enlarged image data corresponding to each beat, and storing the information in the long-term storage area.

<Effects of Fifth Embodiment>

According to the printed material with musical score of the fifth embodiment, it is possible to learn dance form corresponding to each beat while particularly understanding the characteristic part of the body.

### DESCRIPTION OF REFERENCE NUMERALS

1 Printed material with musical score
2 Dance form
3 Area for dance form
4 First area for placement
5 Musical note
6 Area for musical note
7 Second area for placement
8 Words
9 Area for words
10 Third area for placement
11 Enlarged image display

1. A printed material with musical score that is a musical score for expressing dance to the music, comprising:
a first area for placement, where an area for dance motion for expressing a dance form corresponding to each beat of the music is placed.

2. The printed material with musical score according to claim 1, further comprising:
a second area for placement, where an area for musical notes for expressing a corresponding musical note corresponding to each beat of the music is placed.

3. The printed material with musical score according to claim 1, further comprising:
a third area for placement, where an area for words for expressing words corresponding to each beat of the music is placed when the music is a music with words.

4. The printed material with musical score according to claim 1,
wherein a size of the area for dance motion varies according to length of the beat when the length of the beat varies within the music.

5. The printed material with musical score according to claim 1,
wherein the first area for placement is a set of the eight areas for dance motion

6. The printed material with musical score according to claim 1,
wherein, when consecutive areas for dance motion have the same dance form, a dance form displayed in an initial area is not displayed in a subsequent area for dance motion

7. The printed material with musical score according to claim 1,
wherein the dance form is displayed by an image of dance that has been shot.

8. The printed material with musical score according to claim 1,
wherein, when the dance form is characterized by a part of a body, an image of the part of the body is enlarged in the area for dance motion.

9. A display apparatus for displaying the musical score of the printed material with musical score according to claim 1.
